(19) United States
(12) Patent Application Publication
(10) Pub. No.: US 2006/0108563 A1
(43) Pub. Date: May 25, 2006

(54) Luminescent compounds

(75) Inventor: Mark Green, Oxford (GB)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Oxonica Limited, Kidlington (GB)

(21) Appl. No.: 10/524,976

(22) PCT Filed: Aug. 20, 2003
(86) PCT No.: PCT/GB03/03649

§ 371 Date: Nov. 2, 2005

(30) Foreign Application Priority Data
Aug. 20, 2002 (GB) 0219409.0

(51) Int. Cl. C09K 11/08; C09K 11/68

(52) U.S. Cl. 252/301.5; 252/301.4 S; 252/301.4 R; 252/301.4 F; 252/301.4 H

(57) ABSTRACT

A luminescent particle is described having the formula: M²[M¹(POM)] wherein: M² is a cation, M¹ is an ion of a metal capable of providing a luminescent centre or a mixture of two or more thereof, and POM is a polyoxometallate, polythiometallate or polyoxothiometallate of at least one metal of group VA or VIA of the Periodic Table and, optionally, a hetero atom, X, the amounts of X, M₁, M₂ and POM being such as to provide overall neutrality.

This invention relates to luminescent compounds that will absorb in the near UV (defined at least 300 nm) and emit in the visible. Such compounds are of potential use as luminescent tags in a biological diagnostic system or in luminescent security tags.

Most conventional phosphor materials are excited by 200-300 nm UV. This makes such materials of little use for biotagging purposes because these wavelengths are strongly absorbed by biological molecules such as DNA. Accordingly, there is a real need for luminescent centres that excite in the near UV and/or short wavelength blue and which can, nevertheless, be used in biotagging purposes. Excitations from greater than 300 to 400 nm are therefore preferred. In addition, materials which have the potential of being used as a biotag must fully disperse in water and be capable of being incorporated in, typically, silica spheres or other surface coatings which enable them to be attached to the biological molecule. Unfortunately, known materials of rare earth elements such as europium, while absorbing in the near UV and emitting in the visible, are quenched in water via a de-excitation state via a hydroxyl ion. This is a non-radiative effect with the result that the known materials cannot be used for this purpose.

According to the present invention it has surprisingly been found that it is possible to produce luminescent material derived from polyoxo/thiometallates which can coordinate with luminescent centres such as lanthanides such that efficient luminescence can be pumped from the near UV.

According to the present invention there is provided a luminescent particle comprising one or more compounds of the formula:
M²[M¹(POM)]
wherein:
M² is a cation, generally an ion of hydrogen or a metal of group 1A or 2A of the Periodic Table or an optionally substituted ammonium ion, or a mixture of two or more said ions,
M¹ is an ion of a metal capable of providing a luminescent centre or a mixture of two or more thereof, and
POM is a polyoxometallate, a polythiometallate or a polyoxythiometallate (optionally having a hetero atom X as explained below) of at least one metal of group VA or VIA of the Periodic Table, the amounts of X, M¹, M² and POM being such as to provide overall neutrality.

Where a particle contains more than one such compound, then the different compounds thereof may differ in any one or more of the M², M¹, POM or X that they contain. The particles may consist primarily of (i.e. at least 50% by weight of), and preferably consist substantially entirely of (say at least 95% by weight of), the compounds defined above. However, where other materials are present, those other materials may comprises one or more other phosphors. Also, the present particles may be mixed with or otherwise used in conjunction with particles of other phosphors. This can result in a combination of, say, green and red emissions.

Metals of group V and VI of the Periodic Table, (see Chemistry of the Elements, Greenwood & Earnshaw, Pergamon, 1984), notably vanadium, niobium, tantalum, molybdenum and tungsten, are able to form, in their highest oxidation state, metal oxygen/sulphur cluster ions known as polyoxo/thiometallates, and are collectively referred to herein for convenience as “POM”. The invention will be discussed principally in terms of oxo embodiments but it is to be understood that the comments made apply also to the thio and mixed embodiments. The majority of structures are constructed from these transition metals as polyhedrons and may be viewed as arrangements of edge and vertex sharing MO₆ octahedra and have one or two terminal oxygen ions although other polyhedral structures can be formed. At present we prefer POM structures that are symmetrical. It is believed that these POM have a crystal structure which excludes water ions from the inner coordination shell of the emitting ion and which effectively protects europium or other lanthanides from water such that the compounds are not quenched by water.

M² can generally be any cation which does not interfere with the luminescence of the particle. Therefore it should not be an M¹ metal and generally not a transition metal. It is typically an ion of hydrogen or group IA or IIA of the Periodic Table or an optionally substituted ammonium ion. Typically, M² is potassium or sodium or NH₄. However, the ammonium ion may be substituted by, for example, aliphatic or aromatic groups, typically alkyl groups of 1 to 6 carbon atoms such as methyl, ethyl, propyl or butyl and phenyl. All four hydrogen atoms can be replaced by substituents or 1, 2 or 3 hydrogen atoms can remain. A typical organic counterion is tetrabutyl ammonium. M² does not play an active role in the luminescence and acts as a counterion for the remainder of the molecule.

As indicated, M¹ is a metal capable of providing a luminescent centre and is typically a lanthanide although other metals including transition metals such as chromium, titanium and manganese can also be used. Typical ions include Eu³⁺, Tb³⁺, Dy³⁺, Tm³⁺, Er³⁺, Cr³⁺, Ce³⁺, Pr²⁺, Sm³⁺, Nd³⁺, Ho³⁺, Yb³⁺, Ti⁴⁺, Mn²⁺ and Nb⁴⁺. Preferred ions include Eu³⁺, Tb³⁺ and Dy³⁺. In this connection it should be pointed out that, europium, in particular, has in the past been incorporated in POMs but this has been for the purpose of examining crystal structure. In other words there has been no suggestion that the compounds could be used in biotagging or other such applications.

POM is a polyoxo/thiometallate of a group V or group VI metal, in particular vanadium, niobium, tantalum, molybdenum and tungsten, the last two being particularly preferred.

As indicated above, the crystal structure of the POM is particularly important in providing a “shield” for the luminescent centre which is incorporated in it. In addition, in order to maintain a high quantum efficiency, energy transfer from charge transfer state to the optically active centre must be efficient This is believed to be governed by the de-localisation of the electron wave function over the POM structure and this is in turn governed by the M-O-M or M-S-M bond angles. It has been found that this structure can be modified by incorporation of a “heteroelement” X in the POM, where X is for example a transition metal or an element such as B, Al, Si, P, S, Ga, Ge, As, Se, In, Sb, Te, I, Pb or Bi. The use of Si or Al is particularly preferred. The precise nature of the heteroelement is generally unimportant provided that it will form O-M-O—X— linkages.

It is believed that the nature of M governs the absorption wavelength of the light while, of course, M¹ governs the emission. As previously indicated, the heteroelement X can have an effect on the bond angles i.e. the structure which is important for the delocalisation of an electron. It is believed that X does not in itself govern either luminescence or emission.

It is a particular feature of polyoxo/thiometallates that they are frequently formed from more than one metal. Typically M is a mixture, for example of molybdenum and tungsten. Also the number of oxygen atoms which are included in the structure frequently exceeds 10 and is typically 15 to 50. Examples include M₁₀O₃₆, M₆O₁₈, and M₁₁O₃₉; of course the number of oxygen atoms is affected by M¹ and X.

It is a further surprising feature of the present invention that the resulting particles possess a high quantum efficiency which is maintained in aqueous solution as well as in the dry state. In general, the particles will possess a quantum efficiency of at least 1%, preferably at least 5%, more preferably at least 20% and especially at least 35%.

The particles of the present invention can generally readily be made by a self-assembly procedure in an acidified medium. They can generally be prepared by mixing a water soluble source of M² with a water soluble salt of oxo/thiometallate in water or an aqueous solution. Acid, such as hydrochloric or acetic acid, is then added and then generally heated, typically to a temperature of 80° to 90° C. Generally the pH of the solution will be 8 to 9 and this is reduced to, say, 6.5 to 7.5 by the acid. In general, the degree of acidification affects the final structure of the compounds. If a strong acid is added too quickly to produce a pH of less than 3 locally, then this generates product that is non-luminescent. Finally, a water soluble salt of the metal capable of providing the luminescent centre is added, typically as a halide, for example chloride, which is preferred, or nitrate. This generally results in a precipitate enabling the particles to be recovered. Sometimes the precipitate dissolves on stirring. The resulting solution, optionally filtered, can then be cooled to cause the desired product to crystallise.

It has been found that it is generally better to use the same cation for the ingredients as that of the desired M².

It is also possible to form oxo/thiometallate by a solid state reaction, for example by high temperature firing, and to form the final lanthanide-activated compound by reaction with the complex lanthanide at neutral or basic pH.

Monomeric oxometallates such as WO₄²⁻, and MoO₄²⁻ condense in an aqueous acidic media. As there are no electrons available from metallic bonding (due to the maximum valency state of the M ions) the materials are generally held together by closed loops of —O-M-O-M-O— linkages. The structure of the final material is governed by the reaction conditions, principally pH, temperature and the ratio of the reactants. In general, it is recognised that the reactants should be added in the molar proportions that are required in the final product.

If it is desired to incorporate a heteroelement X then this is conveniently added, typically as an oxyanion, for example a silicate, as a water soluble salt. It can generally be added before or after acidification. As well as acidification it has been found that the addition of the heteroelement changes the bond angles and hence the structure of the final product.

Accordingly, the present invention also provides a process for preparing a luminescent particle of the present invention which comprises dissolving a salt of an oxo/thiometallate of M in water together with a water soluble salt of M², adding acid to the resulting solution, subsequently adding a water soluble salt of M¹ and recovering the resulting product, a water soluble salt of an oxo/thioanion of X optionally being added prior to the addition of acid.

The particles obtained by the process typically possess a particle size not exceeding 20 nm, desirably not exceeding 10 nm, preferably not exceeding 5 nm and more preferably not exceeding 2 nm. These sizes are diameters and they assume the particles to be spherical. The particles will in fact usually be substantially spherical; and when they are not spherical the size is to be taken as the diameter of a sphere of the same volume as that of the actual particle.

The luminescent particles of the present invention find utility in a variety, of ways including biotags, drug discovery/development, electroluminescent displays, both AC and DC, magnetic centres of coatings, security marking/labelling/identification, drug delivery and non destructive testing including crack detection as well as in agriculture products. For these purposes they can be delivered by, for example, inkjet, screen printing, injection, dipcoating, or spin coating.

As indicated, the particles of the present invention are particularly useful as phosphors in electroluminescent displays, both AC and DC.

The phosphors also find particular utility in security marking. For this purpose, the phosphors are dispersed in a suitable ink formulation. Typically such formulations involve a binder with the particles. Suitable binders include polymers and resins such as carboxylated acrylic resins and ethylene/vinyl ester copolymers e.g. ethylene/vinyl acetate copolymers e.g. containing about 40% vinyl acetate by weight.

Although it is believed that the particles can sometimes be used as they are for (for example) biotagging and other diagnostic purposes they are typically coated with silica or other material such as titania or zirconia to which an intermediate “biological” molecule can be attached. Alternatively the particles can be capped with an organic acid or Lewis base so that the surface of the particles possesses one or more reactive groups to which a ligand can be attached, the ligand possessing a free reactive group allowing attachment to a biological moiety. Typically ligands which can achieve this include phosphines, phosphine oxides, thiols, amines, carboxylic acids, phosphates, sulfonic acids, sulfinic acids, phosphoric acids, phosphonic acids, phosphinic acids, crown ethers and mixtures of these.

The ligand itself can be monodentate (i.e. with a single binding point, e.g. a trialkylphosphine oxide e.g. with a chain length of 4 to 20 carbon atoms), bidentate (e.g. dihydrolipoic or a dialkyl sulphosuccinate e.g. sodium dioctyl sulphosuccinate with a similar chain length to monodentate) or multi dentate (polymer/dendrimers with pendant side groups such as phosphines, phosphine oxides, thiols, amines, carboxylic acids, phosphates, sulfonic acids, sulfinic acids, phosphoric acids, phosphinic acids and mixtures). The ligand can also be polymeric i.e. a polymer possessing the desired groups. Typically, therefore, copolymers can be used derived from, for example, a vinyl carboxylic acid such as acrylic acid and a vinyl monomer possessing a group capable of binding to the particles such as vinyl phosphonic acid. For some purposes organic and/or polymeric coatings as well as polyelectrolyte coatings can be provided.

The following Examples further illustrate the present invention.

### EXAMPLE 1

Na₉(DyW₁₀O₃₆)

0.025M NaWO₄ are dissolved in deionised water, the pH being >8. The pH is adjusted to 6.5-7.5 with glacial acetic acid at T>80° C. (typically 85-90° C.). To this is added 0.0035M DyCl₃ under vigorous stirring. A precipitation occurs, which substantially disappears with continued stirring at T>80° C. The remaining precipitated material is removed by filtration. The resulting material is filtered once again and the solution is placed at T>5° C. whereupon crystallisation occurs. These crystals are washed with ethanol and recrystallised from hot water. The crystals are then dried in air at room temperature.

This preparation may also be undertaken with Sm instead of Dy to get an orange emitter.

Decay time of emission measured in solid form was of the order of 1.8 ms. By comparison, when the article was dissolved in water, the decay time was about 2.0 ms. This shows that decay time is similar whether the material is in solid form or in water.

### EXAMPLE 2

(NH₄)Tb{Al(OH)₆Mo₆O₁₈].xH₂O

(NH₄)₃[(OH) 6Mo₆O₁₈].xH₂O was prepared by mixing sodium molybdate (2.96×10₋₂M) with A12 (SO₄), (2.47×10⁻³ M) at pH 6 to 7 (altered using acetic acid), followed by refluxing for 30 minutes. Any precipitates were removed by filtration. An excess of NH₄Cl was then added to the solution, forming a white precipitate, which was isolated by filtration. The solid was then dissolved in hot water and left to crystallize at 0 degrees Celsius. 0.01M (NH₄)₃[Al(OH)₆Mo₆O₁₈].xH₂O is dissolved in hot deionised water. To this is added an equimolar amount of TbCl₃ with continuous stirring. The reaction was stirred for 30 minutes then reduced in vacuo to a powder.

### EXAMPLE 3

Na₁₃[Eu(SiMoW₁₀O₃₉)₂]

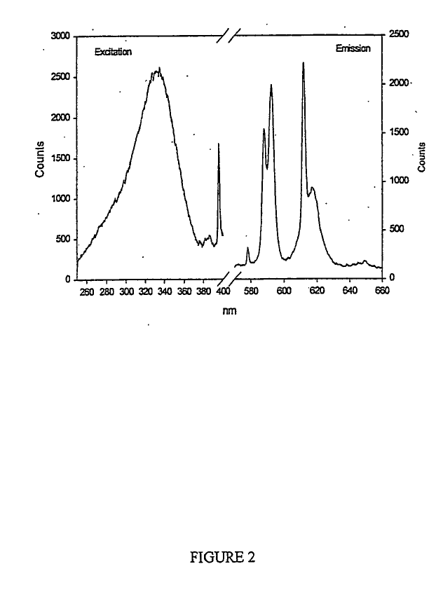

Sodium tungstate dihydrate (3 g, 9.09×10⁻³M), sodium metasilicate (0.19 g, 9.09×10⁴M) and sodium molybdate (0.18 g, 9.09×10⁻⁴) were dispersed in 5 ml 3 M NaCl and heated in water bath (80-90° C.) until dissolved. To this was added a mixture of 1 ml 37% HCl and 1 ml H₂O. An initial clouding and pale green precipitate formed, but re-dissolved upon mixing in the water bath. A slight cloudiness persisted, but this was not removed by filtration. To this solution was added EuNO₃₋ 5H₂O (0.19 g, 4.54×10⁻⁴M) in 2 ml H₂O, whilst stirring a water bath. An immediate precipitate formed. The reaction was stopped after 1-2 minutes and allowed to cool, and the precipitate was removed by centrifugation. The clear aqueous solution luminesces under 340 nm excitation and emits as two peaks in the red at 592 nm and 613 nm as shown in FIG. 2. The solid form of the material is also strongly luminescent.

The mean particle size was about 1.5 nm.

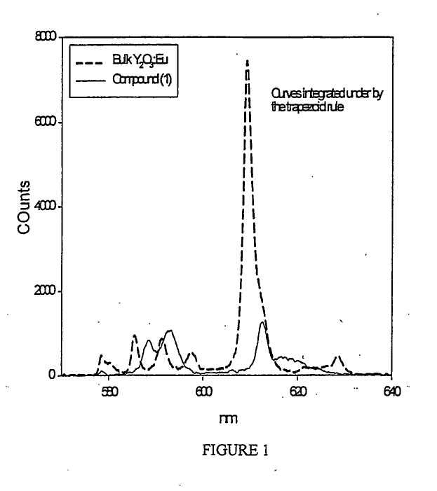

Comparison of the quantum efficiency of the solid form of (1) with a commercial Y₂O₃:Eu phosphor (known efficiency of 70%) shows that the quantum efficiency of the material is 33%. This is shown in FIG. 1.

1. A luminescent particle comprising one or more compounds of the formula:
M²[M¹(POM)]
wherein:
M² is a cation, M¹ is an ion of a metal capable of providing a luminescent centre or a mixture of two or more thereof, and
POM is a polyoxometal late, a polythiometallate or a polyoxythiometallate of at least one metal of group VA or VIA of the Periodic Table and, optionally, a hetero atom X, the amounts of X, M¹, M² and POM being such as to provide overall neutrality.

2. A particle according to claim 1 wherein M¹ is Eu³⁺, Tb³⁺, Dy³⁺, Tm³⁺, Er³⁺, Cr³⁺, Ce³⁺, Pr³⁺, Sm³⁺, Nd³⁺, Ho³⁺, Yb³⁺, Ti⁴⁺ or Mn⁴⁺.

3. A particle according to claim 2 wherein M¹ is Dy³⁺, Eu³⁺ or Tb³⁺.

4. A particle according to claim 1 wherein M is vanadium, niobium, tantalum, molybdenum or tungsten.

5. A particle according to claim 4 wherein M is molybdenum or tungsten.

6. A particle according to claim 1 wherein POM contains a heteroelement X.

7. A particle according to claim 6 wherein X is a transition metal or B, Al, Si, P, S, Ga, Ge, As, Se, In, Sb, Te, I, Pb or Bi.

8. A particle according to claim 7 wherein X is Si or Al.

9. A particle according to claim 1 in which the polyoxymetallate comprises MO₆ octahedra.

10. A particle according to claim 1 wherein M represents more than one metal.

11. A particle according to claim 1 wherein the compound contains at least 15 oxygen atoms.

12. A particle according to claim 1 having a quantum efficiency that is at least 1%.

13. A particle according to claim 12 wherein the quantum efficiency is at least 5%.

14. A particle according to claim 1 wherein M² is an ion of hydrogen or a metal of group 1A or 2A of the Periodic Table or an optionally substituted ammonium ion, or a mixture of two or more said ions.

15. A particle according to claim 14 wherein M² is sodium, potassium or optionally substituted ammonium.

16. A particle according to claim 15 wherein M² is sodium or ammonium.

17. A particle according to claim 1 which has a diameter not exceeding 20 nm.

18. A particle according to claim 17 which has a diameter not exceeding 5 nm.

19. A particle according to claim 1 which possesses a coating rendering the particle suitable for biotagging application.

20. A particle according to claim 19 wherein the coating is of silica.

21. (canceled)

22. A process for preparing a particle as claimed in claim 1 which comprises dissolving a water soluble salt of an oxo/thiometallate of M and optionally of an oxo/thioanion of X and a water soluble salt of M² in water, adding acid, and then adding a water soluble salt of M¹ and recovering the resulting product.

23. A process according to claim 22 wherein the salts are all of M².

24. A process according to claim 22 or 23 wherein the acid is acetic acid or hydrochloric acid.

25. A process according to claim 22 wherein the mixture is heated before the acid is added.

26. A process according to claim 22 wherein a water soluble salt of an oxo/thio anion of X is added with the water soluble salt of the oxo/thiometallate of M.

27. (canceled)

28. A particle as claimed in claim 1 for use in biotagging, drug discovery/development, electroluminescent displays, magnetic centres of coatings, security marking/labelling/identification, drug delivery, non-destructive testing or in agricultural products.
